(19) United States
(12) Patent Application Publication
(10) Pub. No.: US 2010/0141471 A1
(43) Pub. Date: Jun. 10, 2010

(54) HANDHELD APPARATUS FOR READING RFID TAG INFORMATION

(75) Inventors: Katsumi Toda, Aichi (JP); Yuta Inagaki, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/711,485

(22) Filed: Feb. 24, 2010

Related U.S. Application Data
(63) Continuation-in-part of application No. PCT/JP2008/066323, filed on Sep. 10, 2008.

(30) Foreign Application Priority Data
Sep. 27, 2007 (JP) 2007-251756

(51) Int. Cl. G08B 5/22; G06K 7/01; G09G 5/02

(52) U.S. Cl. 340/825.36; 340/10.6; 345/593

(57) ABSTRACT

The disclosure discloses a handheld apparatus for reading RFID tag information comprising: a radio communicating device configured to conduct radio communication with a plurality of RFID tag circuit elements; a display device configured to display display information corresponding to said RFID tag circuit elements; an information obtainment device configured to specify identification information of said RFID tag circuit elements selected by said operator among said RFID tag circuit elements whose display information is displayed on said display device, to conduct communication, and to obtain information from the RFID tag circuit element specified; and a display control portion configured, when said information obtainment device obtains the information from said RFID tag circuit element, to make a display mode of said display information corresponding to the RFID tag circuit element on said display device different at least partially from a display mode before the obtainment of information.

### CROSS-REFERENCE TO RELATED APPLICATION

This is a CIP application PCT/JP2008/066323, filed Sep. 10, 2008, which was not published under PCT article 21(2) in English.

### BACKGROUND OF THE INVENTION

1. Field of the Invention

The present invention relates to a handheld apparatus for reading an RFID tag information configured to read information via radio communication from a radio frequency identification (RFID) tag circuit element provided with an IC circuit part storing information and a tag antenna capable of information transmission and reception.

2. Description of the Related Art

An RFID system has been proposed recently and put into practice in various fields. In this RFID system, information reading and writing is performed in a non-contact manner between a small-sized RFID tag provided with an RFID tag circuit element and a reader/writer, which is a reading device and writing device. The RFID tag circuit element has an IC circuit part storing predetermined RFID tag information and an antenna connected to this IC circuit part for information transmission and reception.

A handheld apparatus for reading RFID tag information to which the RFID system is applied has been already proposed. In the handheld apparatus of the prior art reference, various search conditions are stored in advance in a storage portion. If an operator selects a desired condition from the applicable search conditions, reading of RFID tag information of a search target, that is, search is made via radio communication. As the result of the search, if a search target matching the search condition is found, the fact is notified to the operator.

In the prior art reference, the handheld apparatus for reading RFID tag information determines if information of a search target read via radio communication matches a search condition or not, and if it is matched, the fact that the search target is present is only notified to the operator. Therefore, if an operator selects a plurality of search conditions, for example, even if the read information matches a part of the plurality of search conditions, the fact that the search target is present is notified to the operator. That is, if the operator sets two author names as a search condition, for example, if a book of either of the authors is found, the fact that the search target is present is notified to the operator in the prior art reference. In this case, the operator cannot immediately recognize a book of which of the authors is found, and display is not easy to understand for the operator.

### SUMMARY OF THE INVENTION

The present invention has an object to provide a handheld apparatus for reading RFID tag information that can simplify a search operation and display of a search result for an operator.

There are provided a radio communicating device configured to conduct radio communication with a plurality of RFID tag circuit elements including an IC circuit part storing information and a tag antenna capable of information transmission and reception, a display device configured to display display information corresponding to at least one of the RFID tag circuit elements as search targets so that an operator can select, an information obtainment device configured to specify identification information of at least one of the RFID tag circuit elements selected by the operator among the RFID tag circuit elements as the search targets whose display information is displayed on the display device, to conduct communication through the radio communicating device, and to obtain information from the IC circuit part of the RFID tag circuit element specified, and a display control portion configured, when the information obtainment device obtains the information from the RFID tag circuit element, to make a display mode of the display information corresponding to the RFID tag circuit element on the display device different at least partially from a display mode of the display information corresponding to the RFID tag circuit element before the obtainment of information.

### BRIEF DESCRIPTION OF THE DRAWING

FIG. 1 is a diagram illustrating an example of a use mode of a reader, which is a handheld apparatus for reading RFID tag information of this embodiment;

FIG. 2 is a configuration diagram illustrating an outline configuration of the reader of this embodiment;

FIG. 3 is a functional block diagram illustrating a function of a display control portion;

FIG. 4 is a plan view illustrating an entire appearance of the reader;

FIG. 5 is a functional block diagram illustrating detailed configurations of a CPU, an RF communication control portion, and a reader antenna in the reader;

FIG. 6 is a block diagram illustrating an example of a functional configuration of an RFID tag circuit element disposed in an RFID tag;

FIG. 7A is a diagram illustrating an example of a display screen of a liquid crystal panel in a search;

FIG. 7B is a diagram illustrating an example of the display screen of the liquid crystal panel in a search;

FIG. 7C is a diagram illustrating an example of the display screen of the liquid crystal panel in a search;

FIG. 8A is a diagram illustrating an example of the display screen of the liquid crystal panel in a variation in which the screen is scrolled so that display information relating to the detected RFID tag is displayed;

FIG. 8B is a diagram illustrating an example of the display screen of the liquid crystal panel in a variation in which the screen is scrolled so that display information relating to the detected RFID tag is displayed;

FIG. 8C is a diagram illustrating an example of the display screen of the liquid crystal panel in a variation in which the screen is scrolled so that display information relating to the detected RFID tag is displayed;

FIG. 9A is a diagram illustrating an example of the display screen of the liquid crystal panel in a variation in which an order of detection is displayed;

FIG. 9B is a diagram illustrating an example of the display screen of the liquid crystal panel in a variation in which an order of detection is displayed;

FIG. 9C is a diagram illustrating an example of the display screen of the liquid crystal panel in a variation in which an order of detection is displayed;

FIG. 10A is a diagram illustrating an example of the display screen of the liquid crystal panel in a variation in which received signal intensity and power are displayed;

FIG. 10B is a diagram illustrating an example of the display screen of the liquid crystal panel in a variation in which received signal intensity and power are displayed;

FIG. 10C is a diagram illustrating an example of the display screen of the liquid crystal panel in a variation in which received signal intensity and power are displayed;

FIG. 11A is a diagram illustrating an example of the display screen of the liquid crystal panel in a variation in which a font or character decoration, for example, is changed;

FIG. 11B is a diagram illustrating an example of the display screen of the liquid crystal panel in a variation in which a font or character decoration, for example, is changed;

FIG. 11C is a diagram illustrating an example of the display screen of the liquid crystal panel in a variation in which a font or character decoration, for example, is changed;

FIG. 12A is a diagram illustrating an example of the display screen of the liquid crystal panel in a variation in which an information amount to be displayed is increased;

FIG. 12B is a diagram illustrating an example of the display screen of the liquid crystal panel in a variation in which an information amount to be displayed is increased;

FIG. 12C is a diagram illustrating an example of the display screen of the liquid crystal panel in a variation in which an information amount to be displayed is increased;

FIG. 13A is a diagram illustrating an example of the display screen of the liquid crystal panel in a variation in which a display area other than the display information relating to the detected RFID tag is deleted;

FIG. 13B is a diagram illustrating an example of the display screen of the liquid crystal panel in a variation in which a display area other than the display information relating to the detected RFID tag is deleted;

FIG. 13C is a diagram illustrating an example of the display screen of the liquid crystal panel in a variation in which a display area other than the display information relating to the detected RFID tag is deleted;

FIG. 14A is a diagram illustrating an example of the display screen of the liquid crystal panel in a variation in which the display information relating to the detected RFID tag is made not to be displayed;

FIG. 14B is a diagram illustrating an example of the display screen of the liquid crystal panel in a variation in which the display information relating to the detected RFID tag is made not to be displayed;

FIG. 14C is a diagram illustrating an example of the display screen of the liquid crystal panel in a variation in which the display information relating to the detected RFID tag is made not to be displayed;

FIG. 15A is a diagram illustrating an example of the display screen of the liquid crystal panel in a variation in which a result at timeout is displayed; and

FIG. 15B is a diagram illustrating an example of the display screen of the liquid crystal panel in a variation in which a result at timeout is displayed.

### DETAILED DESCRIPTION OF THE PREFERRED EMBODIMENTS

An embodiment of the present invention will be described below referring to the attached drawings.

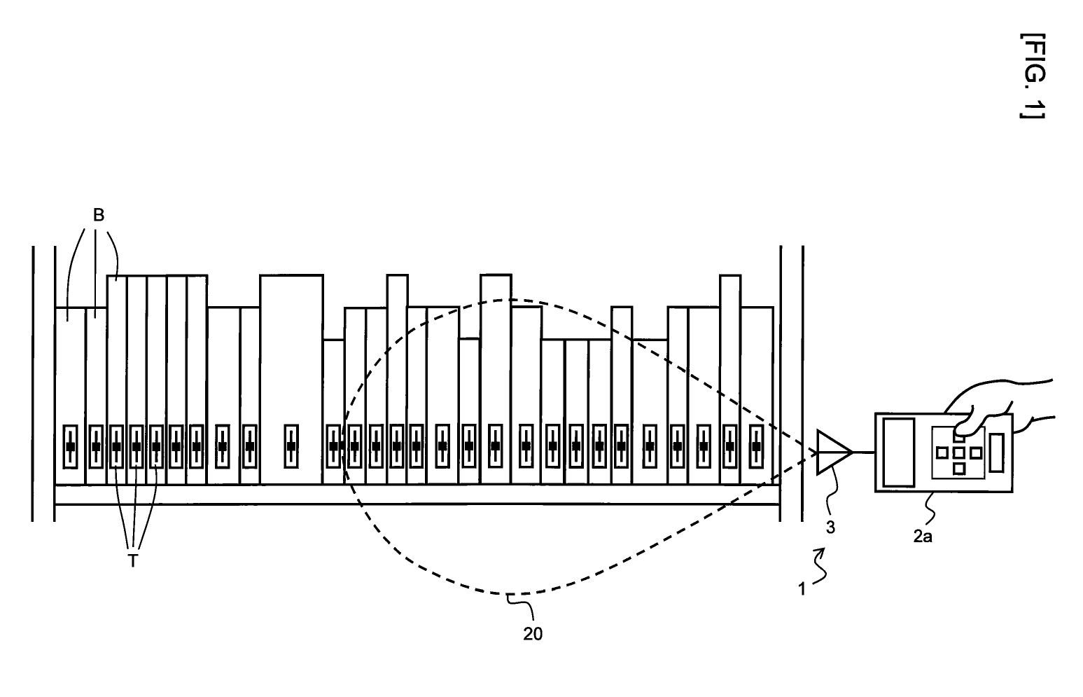

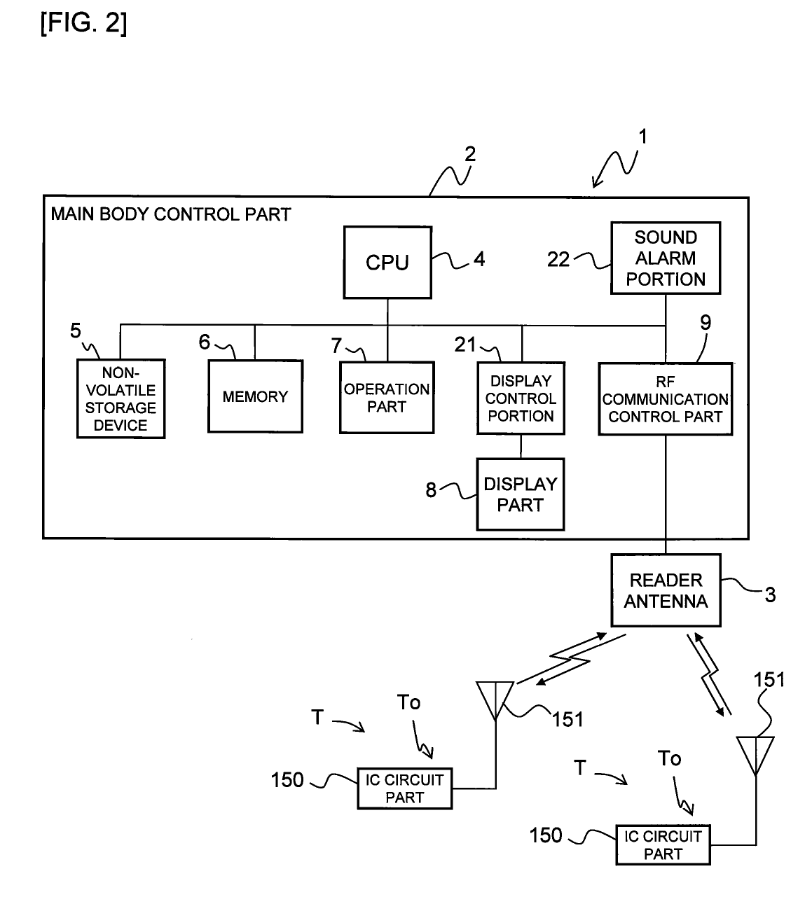

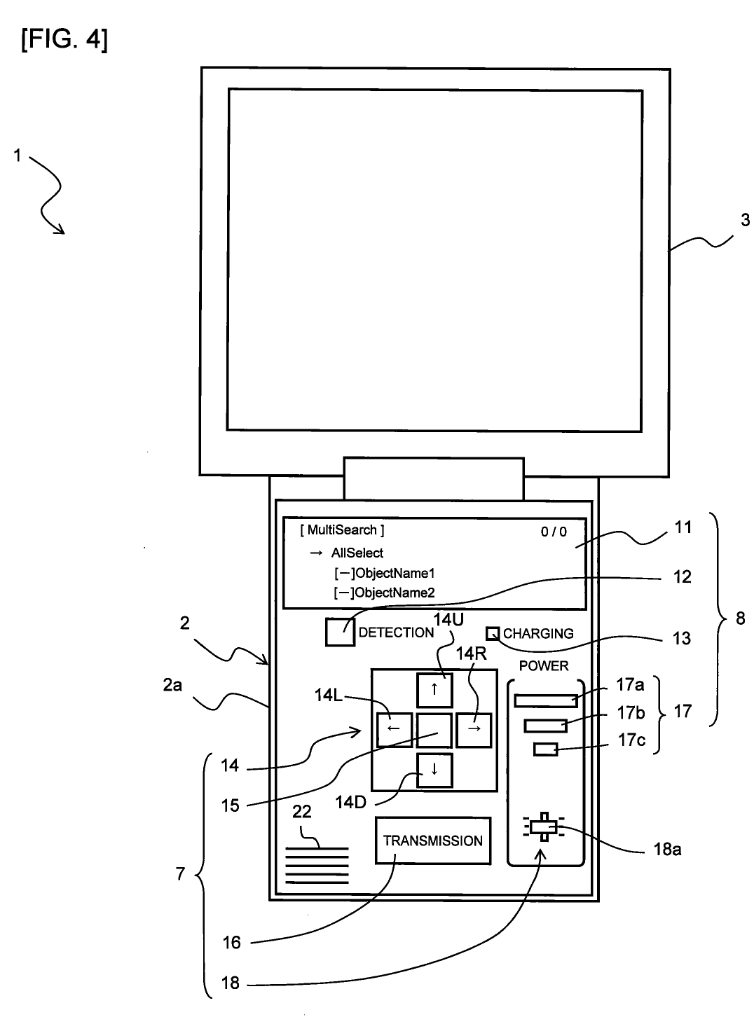

An example in FIG. 1 illustrates a case in which a book material stored in a cabinet is searched. In the illustrated example, a plurality of book materials B are stored on a single shelf in the cabinet. These plurality of book materials B are arranged horizontally (that is, right and left direction in the figure) with a longitudinal direction of the respective spine labels in a perpendicular direction. An RFID tag T is attached to a spine label of each book material B, respectively. A reader 1, which is a handheld apparatus for reading RFID tag information of this embodiment, is a handheld type and includes a housing 2a. In the housing 2a, an operation part 7 and a display part 8 are disposed (See FIGS. 2 and 4, which will be described later).

An operator of the reader 1 is a person who is searching a necessary book material B, for example. The operator makes input setting of a list of the book materials B in the reader 1 in advance through the operation part 7. The number of lists to be set may be one or plural. After that, the user takes the reader 1 in hand and moves the reader 1 from one side end portion to the other side end portion of a row of the plurality of book materials B. In the moving state, the reader 1 transmits and receives information to and from an RFID tag T attached to each book B via radio communication. As a result, the reader 1 searches if each book material B set in the list is present in a communicable area 20 of the reader 1 or not, respectively. A range indicated by a broken line in the figure represents the communicable area 20.

The reader 1 has, as shown in FIG. 2, a main body control part 2 and a reader antenna 3 constituting a part of the radio communicating device. The main body control part 2 has a CPU 4 functioning as the information obtainment device, a non-volatile storage device 5, memory 6, the operation part 7, the display part 8, a display control portion 21, a Radio Frequency (hereinafter referred to as RF) communication control part 9 constituting a part of the radio communicating device, and a sound alarm portion 22.

The non-volatile storage device 5 includes a hard disk device and a flash memory, for example, and stores information relating to all the book materials B, for example. The memory 6 includes a RAM and a ROM, for example. In the operation part 7, an instruction and information from the operator is inputted. The display part 8 displays various kinds of information and messages. The display control portion 21 controls display performed by the display part 8. The RF communication control part 9 controls radio communication with the RFID tag T through the reader antenna 3. The sound alarm portion 22 alarms various kinds of information and messages.

The CPU 4 executes signal processing according to a program stored in the ROM in advance using a temporary storage function of the RAM so as to perform various control of the entire reader 1.

The RFID tag T is provided with an RFID tag circuit element To and a base material, not shown, on which the RFID tag circuit element To is arranged, for example. The RFID tag circuit element To is provided with a tag antenna 151 and an IC circuit part 150. Also, the RFID tag T can be attached to an article such as the book material B.

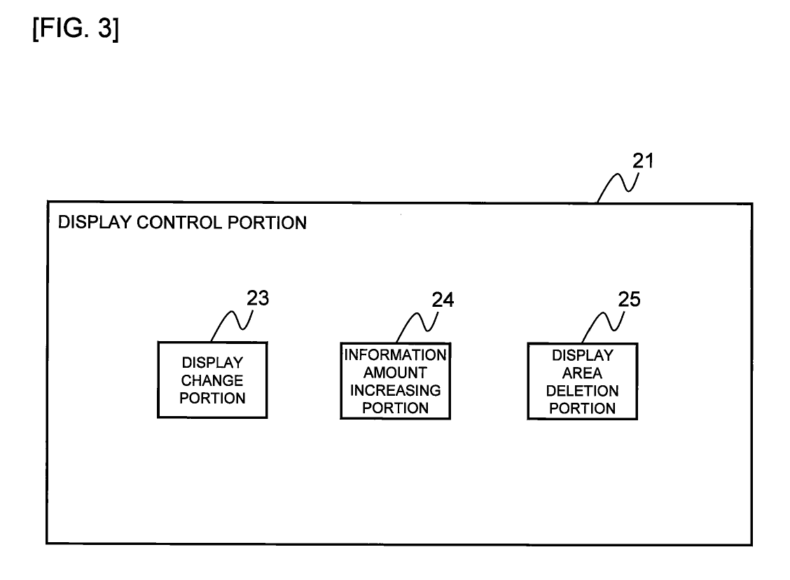

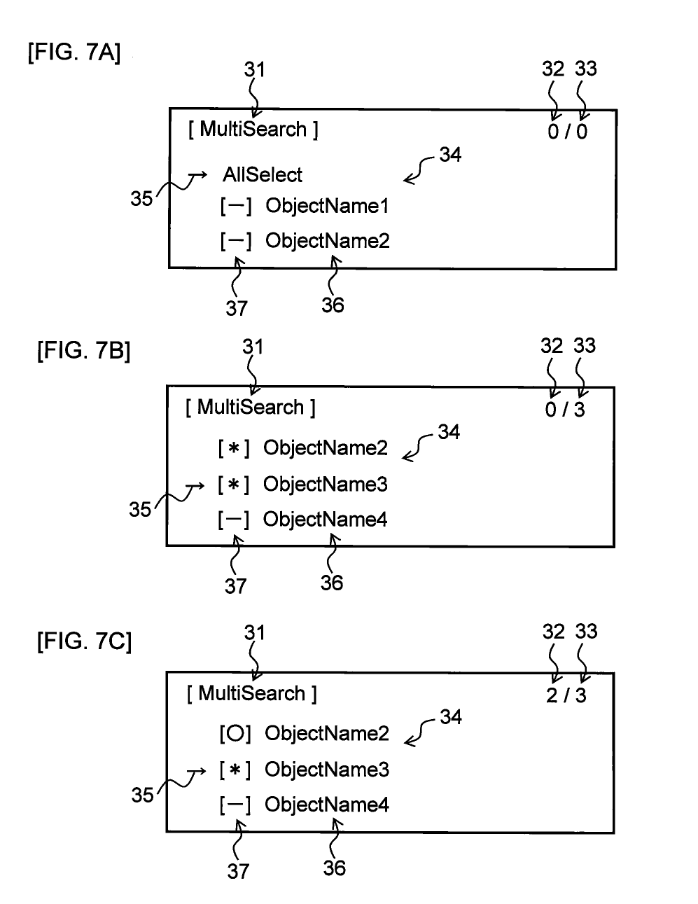

By means of control of the display control portion 21, the display part 8, as shown in FIG. 3, displays the display information corresponding to the RFID tag circuit element To of at least one RFID tag T disposed on the book material B (See FIG. 7, which will be described later) so that the operator can make a choice. An example of the display information includes a book name, for example. A liquid crystal panel 11, which will be described later, is disposed on the display part 8, and the book names, for example, are displayed on the liquid crystal panel 11.

Also, the display control portion 21 has a display change portion 23, an information amount increase portion 24, and a display area deletion portion 25.

The display change portion 23 controls the display part 8 so as to change a display mode of the display information. That is, by means of control of the display change portion 23, the display part 8 changes the display mode of at least a part of an area of the display information displayed before information obtainment by the reader 1 via radio communication to another display mode after the information obtainment (See FIG. 7, which will be described later).

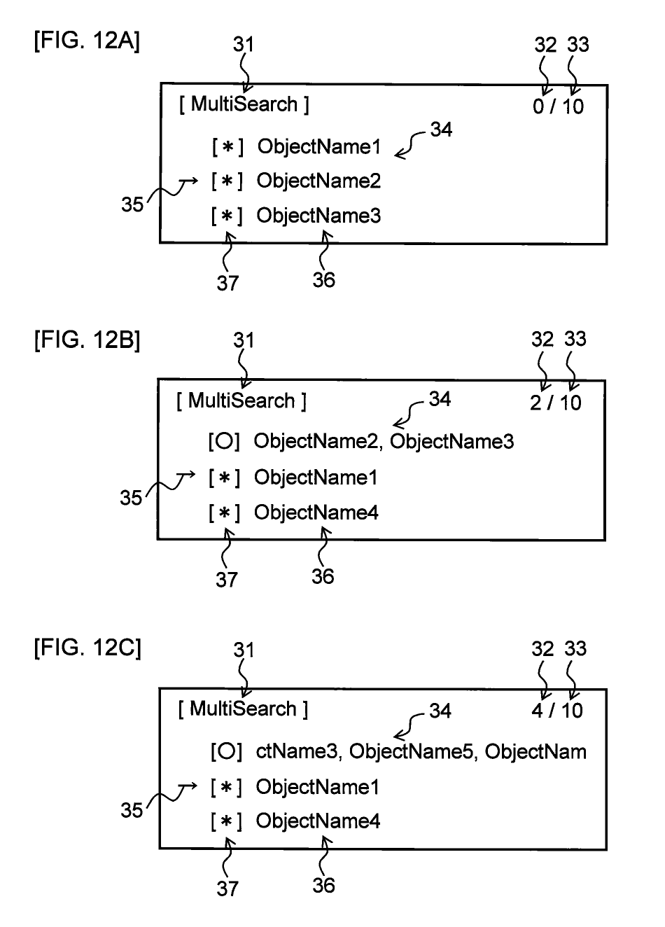

The information amount increase portion 24 controls the display part 8 so as to increase an information amount included in the display information. That is, by means of control of the information amount increase portion 24, the display part 8 increases the information amount included in the display information displayed after the information obtainment by the reader 1 via radio communication larger than the information amount included in the display information displayed before the information obtainment by the reader 1 via radio communication (See FIG. 12, which will be described later).

The display area deletion portion 25 controls the display part 8 so as to delete a display area for those other than predetermined display information according to sequential increase of the number of RFID tag circuit elements To for which information obtainment has been completed by the reader 1 via radio communication. That is, by means of control of the display area deletion portion 25, the display part 8 deletes the display area for those other than the plurality of pieces of display information so that the plurality of pieces of display information relating to the plurality of RFID tag circuit elements To for which information obtainment has been completed can be displayed in a list.

An appearance structure of the reader 1 will be described using FIG. 4. As shown in FIG. 4, the reader 1 is provided with the housing 2a of the main body control part 2 and the reader antenna 3. The housing 2a is formed substantially in a rectangular solid. The reader antenna 3 is disposed integrally with the housing 2a at one end portion of the housing 2a in the longitudinal direction, that is, an upper end portion in an illustrated example. The communicable area 20 of the reader 1 is formed on a longitudinal extension of the housing 2a from the reader antenna 3, that is, with directivity extending upward in FIG. 4. In a use example shown in FIG. 1, the reader 1 performs search processing while the operator holds the housing 2a in hand and directs the reader antenna 3 toward the plurality of the book materials B.

On a plane on one side, that is, a face on the illustrated front side of the housing 2a, a liquid crystal panel 11 as the display device, a detection lamp 12, a charging lamp 13, four direction keys 14U, 14D, 14L, 14R, a determination key 15, a transmission key 16, a power indicator 17, a transmission intensity adjusting slider 18, and the sound alarm portion 22 are disposed.

The liquid crystal panel 11 is arranged on an upper side in the figure. The detection lamp 12 and the charging lamp 13 are arranged on a lower side in the figure of the liquid crystal panel 11. The direction keys 14U, 14D, 14L, 14R are arranged in a cross shape substantially at the center in the figure. The determination key 15 is arranged at the center of the direction keys 14U, 14D, 14L, 14R. The transmission key 16 is arranged on the lower side of the figure. The power indicator 17 is arranged on the right side of the direction keys 14U, 14D, 14L, 14R. The transmission intensity adjusting slider 18 is arranged on the right side of the transmission key 16. The sound alarm portion 22 is arranged on the left side of the transmission key 16.

Among them, the four direction keys 14U, 14D, 14L, 14R, the determination key 15, the transmission key 16, and the transmission intensity adjusting slider 18 constitute the operation part 7. The liquid crystal panel 11, the detection lamp 12, the charging lamp 13, and the power indicator 17 constitute the display part 8.

The liquid crystal panel 11 displays a switching state of various operation modes executed by the reader 1, detailed contents in each operation mode, various kinds of information and messages, for example, in letters and symbols. The operation modes include a single search mode, a multi search mode, an inventory mode, a list-up mode, and an option mode. The illustrated example shows that processing of the multi search mode is being executed.

In processing of the single search mode, one RFID tag T is specified by the operator in at least one RFID tag T as a search target displayed on the liquid crystal panel 11. Then, the reader 1 continues communication all the time to inquire if the specified RFID tag T as a search target is present in the communicable area 20 or not. At this time, the reader 1 determines availability of radio communication with the RFID tag T in each stage while changing the communicable area 20 in a stepped manner from a minimum range to a maximum range with respect to the specified RFID tag T. As a result, the reader 1 detects the minimum communicable area capable of radio communication. Then, the reader 1 can detect an approximate separated distance from the reader 1 to the RFID tag T as a search target on the basis of a power corresponding to the minimum communication area.

In processing of the multi search mode, a plurality of the RFID tags T are specified by the operator in the at least one RFID tag T as a search target displayed on the liquid crystal panel 11. Then, the reader 1 continues communication all the time to inquire if the specified plurality of RFID tags T are present in the communicable area 20 of the reader 1 or not. At this time, too, the reader 1 determines availability of radio communication with the RFID tag T in each stage while changing the communicable area 20 in a stepped manner from the minimum range to the maximum range with respect to the specified plurality of RFID tags T. As a result, the reader 1 detects the minimum communicable area capable of radio communication and can detect an approximate separated distance from the reader 1 to each RFID tag T on the basis of the power corresponding to the minimum communication area.

Processing of the inventory mode is processing to retry only if the plurality of RFID tags T as search targets specified by the operator in advance can be detected or not. Since in this mode, only presence matters, and the reader 1 finishes the processing once all the specified plurality of RFID tags T as search targets have been detected.

In processing of the list-up mode, the operator does not specify a search target. This list-up processing is processing to conduct radio communication with the RFID tags T as search targets present in the range of the communicable area 20 of the reader 1 and to list up all the detected RFID tags T.

Processing of the option mode is processing to set various functions in the reader 1 such as sound ON and OFF by the sound alarm portion 22 and ON and OFF of a vibrator function, for example.

Switching of the five operation modes is performed by operation by the operator of the right and left directional keys 14L and 14R in the above four directional keys 14U, 14D, 14L, and 14R.

The detection lamp 12 and the charging lamp 13 are both display function parts using light-emitting elements such as an LED. The detection lamp 12 displays presence of detection of the specified RFID tag T as a search target by a difference between being lighted and not lighted. The charging lamp 13 displays a charged state of the battery by a difference between being lighted and not lighted.

The power indicator 17 includes three light-emitting elements aligned vertically in the figure, that is, LEDs 17a, 17b, 17c. The power indicator 17 displays intensity of the power in a stepped manner by the number of lighted elements of the LEDs 17a, 17b, and 17c. In the illustrated example, the power is displayed in three stages.

The direction keys 14U, 14D, 14L, 14R are press-in type key switches assigned capable of instructing vertical and horizontal directions. To each of the direction keys 14U, 14D, 14L, 14R, the instructing directions corresponding to a positional relation with respect to the center of the cross arrangement are assigned. The direction keys 14U, 14D, 14L, 14R are used for a movement instruction of a cursor displayed on the liquid crystal panel 11 or a selection instruction of a plurality of options.

The determination key 15 is used for a determination instruction of such a selection by the four direction keys 14U, 14D, 14L, 14R.

The transmission key 16 is a key switch used to transmit various instruction commands and to instruct start of information transmission, that is, start of radio communication to the RFID tag T as a search target.

The transmission intensity adjusting slider 18 is a slider-type switch. A position of a knob 18a can move vertically in the figure in a stepped manner. In the illustrated example, the position of the knob 18 can be moved in three stages. The operator can make fine adjustment of the intensity of a radio wave outputted from the reader antenna 3, that is, a power using the transmission intensity adjusting slider 18.

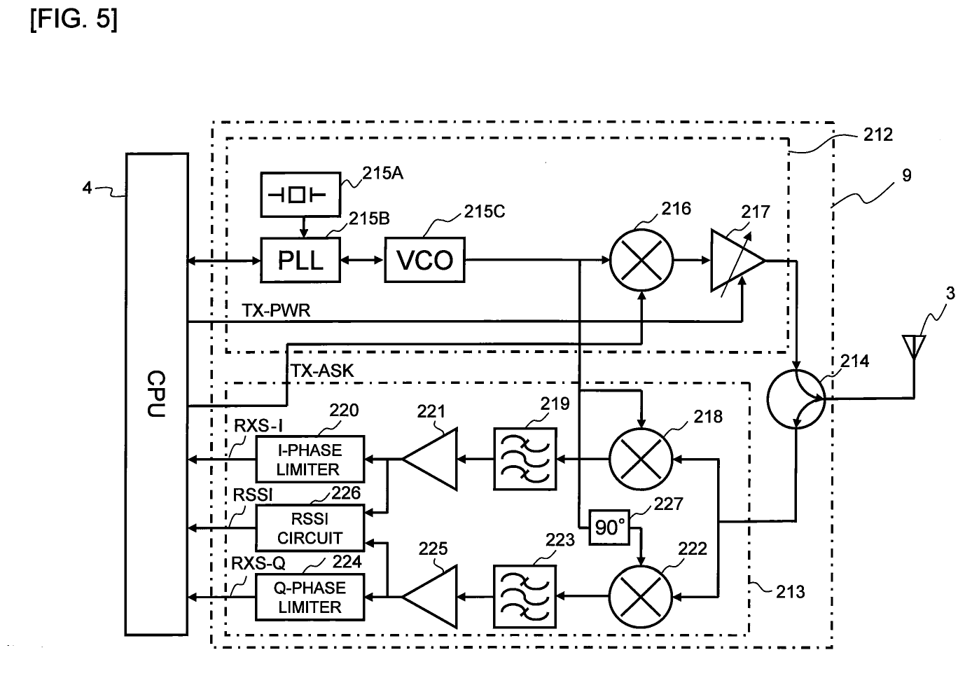

In FIG. 5, the RF communication control part 9 accesses information containing the tag ID stored in the IC circuit part 150 of the RFID tag circuit element To through the reader antenna 3.

The CPU 4 processes a signal read of the IC circuit part 150 of the RFID tag circuit element To so as to read information and also generates various commands to access the IC circuit part 150 of the RFID tag circuit element To. The details will be described later.

The RF communication control part 9 includes a transmitting portion 212, a receiving portion 213, and a transmit-receive splitter 214.

The transmitting portion 212 is a block configured to generate an interrogation wave to access RFID tag information of the IC circuit part 150 of the RFID tag circuit element To for reading through the reader antenna 3. The transmitting portion 212 includes a crystal oscillator 215A, a Phase Locked Loop (hereinafter referred to as a “PLL”) 215B, a Voltage Controlled Oscillator (hereinafter referred to as a “VCO”) 215C, a transmission multiplying circuit 216, and a gain control transmission amplifier 217.

The crystal oscillator 215A outputs a reference signal of a frequency. The PLL 215B generates a carrier wave with a predetermined frequency by dividing and multiplying an output of the crystal oscillator 215A by means of control of the CPU 4. The VCO 215C outputs a carrier wave with a frequency determined based on a control voltage generated by the PLL 215B. As the frequency of the generated carrier wave, a UHF band, a micro wave band or a short-wave band frequency, for example, is used.

The transmission multiplying circuit 216 modulates the carrier wave generated based on the signal supplied from the CPU 4. In this example, the transmission multiplying circuit 216 executes amplitude modulation on the basis of a “TX_ASK” signal from the CPU 4. In the case of such amplitude modulation, an amplification rate variable amplifier, for example, may be used instead of the transmission multiplying circuit 216.

The gain control transmission amplifier 217 amplifies the modulated wave modulated by the transmission multiplying circuit 216. In this example, the gain control transmission amplifier 217 performs amplification with an amplification rate determined by a “TX_PWR” signal from the CPU 4. The output of the transmission amplifier 217 is transmitted to the reader antenna 3 through the transmit-receive splitter 214, radiated from the reader antenna 3 as an interrogation wave and supplied to the IC circuit part 150 of the RFID tag circuit element To. The interrogation wave is not limited to the modulated signal, that is, the modulated wave as above, but the wave might be a simple carrier wave.

The receiving portion 213 receives an input of a response wave from the RFID tag circuit element To received by the reader antenna 3. The receiving portion 213 is provided with an I-phase receiving signal multiplying circuit 218, an I-phase band-pass filter 219, an I-phase receiving signal amplifier 221, an I-phase limiter 220, a phase shifter 227, a Q-phase receiving signal multiplying circuit 222, a Q-phase band-pass filter 223, a Q-phase receiving signal amplifier 225, a Q-phase limiter 224, and a Received Signal Strength Indicator (hereinafter referred to as an “RSSI”) circuit 226 as an intensity detecting device.

The I-phase receiving signal multiplying circuit 218 multiplies and demodulates the response wave from the RFID tag circuit element To received by the reader antenna 3 and inputted through the transmit-receive splitter 214 and a band-pass filter 227 and the generated carrier wave.

The I-phase band-pass filter 219 takes out only a signal in a required band from the output of the I-phase receiving signal multiplying circuit 218. The I-phase receiving signal amplifier 221 amplifies an output of the I-phase band-pass filter 219. The I-phase limiter 220 further amplifies the output of the I-phase receiving signal amplifier 221 and converts it to a digital signal.

The phase shifter 227 delays a phase of the carrier wave generated as above by 90°. The Q-phase receiving signal multiplying circuit 222 multiplies the response wave from the RFID tag circuit element To received at the reader antenna 3 and the carrier wave whose phase is delayed by the phase shifter 227 by 90°. The Q-phase band-pass filter 223 takes out only a signal in a required band from the output of the Q-phase receiving signal multiplying circuit 222. The Q-phase receiving signal amplifier 225 amplifies an output of the Q-phase band-pass filter 223. The Q-phase limiter 224 further amplifies the output of the Q-phase receiving signal amplifier 225 and converts it to a digital signal.

A signal “RXS-I” outputted from the I-phase limiter 220 and a signal “RXS-Q” outputted from the Q-phase limiter 224 are inputted into the CPU 4 and processed. The outputs from the I-phase receiving signal amplifier 221 and the Q-phase receiving signal amplifier 225 are also inputted into the RSSI circuit 226 and a signal “RSSI” indicating the intensity of these signals is inputted into the CPU 4. As above, the reader 1 demodulates the response wave from the RFID tag circuit element To by I-Q quadrature demodulation.

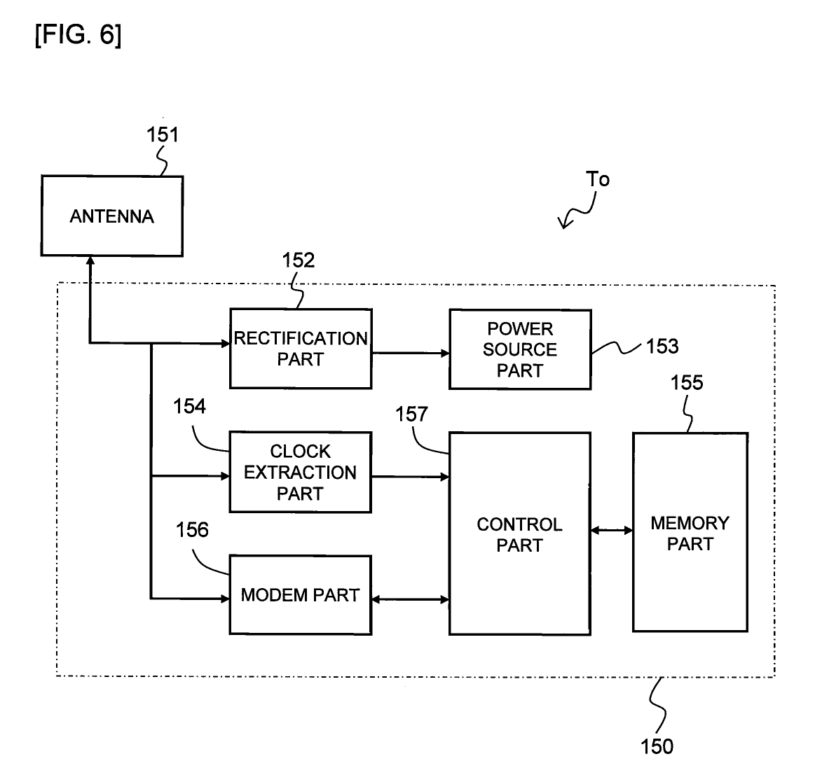

The RFID tag circuit element To has, as shown in FIG. 6, the tag antenna 151 performing transmission and reception of a signal in a non-contact manner with the reader antenna 3 of the reader 1 and the IC circuit part 150 connected to the tag antenna 151.

The IC circuit part 150 includes a rectification part 152, a power source part 153, a clock extraction part 154, a memory part 155, a modem part 156, and a control part 157. The rectification part 152 rectifies an interrogation wave received by the tag antenna 151. The power source part 153 accumulates energy of the interrogation wave rectified by the rectification part 152 and uses the energy as a driving power source of the RFID tag circuit element To. The clock extraction part 154 extracts a clock signal from the interrogation wave received by the tag antenna 151 and supplies the signal to the control part 157. The memory part 155 stores a predetermined information signal. The control part 157 controls operations of the RFID tag circuit element To through the memory part 155, the clock extraction part 154, and the modem part 156, for example.

The modem part 156 demodulates an interrogation wave from the reader antenna 3 of the reader 1, received by the tag antenna 151. The modem part 156 also modulates a reply signal from the control part 157 and transmits it as a response wave, that is, a signal including the tag ID, from the tag antenna 151.

The clock extraction part 154 extracts a clock component from the received signal and supplies a clock corresponding to a frequency of the clock component of the received signal to the control part 157.

The control part 157 interprets a received signal demodulated by the modem part 156 and generates a reply signal on the basis of the information signal stored in the memory part 155. Then, the modem part 156 transmits the reply signal through the tag antenna 151.

In the memory part 155, a tag ID uniquely set as identification information to specify an individual RFID tag circuit element To is stored in advance. The tag ID is set with the sole content that is never duplicated.

The most distinguished characteristic of the reader 1 of this embodiment is as follows. That is, when an operator searches the RFID tag T to be searched, the operator can specify single display information in the display information relating to at least one RFID tag T displayed on the liquid crystal panel 11. Then, a display mode of an area of at least a part of the display information displayed by the liquid crystal panel 11 before the RFID tag information is obtained from the RFID tag T to be searched is changed after obtainment of the RFID tag information. The details of the display will be described below.

First, if the operator operates the right and left directional keys 14L and 14R and selects the multi search mode, an initial screen shown in FIG. 7A is displayed at first. In FIG. 7A, a mode display portion 31 is displayed in the upper left on the screen, while a detection number display portion 32 and a selection number display portion 33 are displayed in the upper right on the screen.

The mode display portion 31 displays “MultiSearch” indicating the selected operation mode and corresponding to the multi search mode in this example. The detection number display portion 32 indicates the number of RFID tag T detected via radio communication. The selection number display portion 33 indicates the total of the RFID tags T selected by the operator. Also, below the mode display portion 31, a search-target selection display portion 34 for selecting the RFID tag T to be searched is displayed.

The search-target selection display portion 34 has a cursor portion 35 movable by the operator who operates the up and down directional keys 14U and 14D, a text portion 36, and a mark portion 37. “AllSelect” displayed at the uppermost part of the search-target selection display portion 34 is display used when all in the search target list displayed below that are selected. That is, if the operator operates the determination key 15 while the cursor portion 35 points at the “AllSelect”, all in the search target list displayed on the search-target selection display portion 34 are selected. The text portion 36 indicates an article name or identification number, for example, on which the RFID tag T to be searched is disposed. A mark “−”, which is an identifier of the mark portion 37 indicates that the corresponding RFID tag T has not been selected as a search target.

If the operator operates the down directional key 14D to lower the cursor portion 35 and operates the determination key 15 for names of “ObjectName1” to “ObjectName3”, respectively, so as to select them as search targets from the display state shown in FIG. 7A, the display state is changed to a state shown in FIG. 7B. At this time, the search-target selection display portion 34 is automatically scrolled downward according to a lowering operation of the cursor portion 35.

As shown in the figure, the mark portion 37 corresponding each of the names of the “ObjectName1” to “ObjectName3” has been changed to display of another mark “*” from the mark “−” since they were selected. However, the “ObjectName1” is not displayed since the search-target selection display portion 34 has been scrolled downward.

Also, the display of the selection number display portion 33 is added each time the search target is selected, and the selection total of the search targets of “3” is displayed in this example. Since the “ObjectName4” is not selected, the display of the mark portion 37 remains to be “−”.

In the display state shown in FIG. 7B, if the operator operates the transmission key 16, the CPU 4 of the main body control portion 2 in the reader 1 specifies the tag ID of the RFID tag circuit element To of the selected RFID tag T to be searched and starts radio communication. As a result, for the RFID tag T for which the RFID tag information can be obtained from the IC circuit part 150 of the RFID tag circuit element To, as shown in FIG. 7C, the display of the corresponding mark portion 37 is changed from the mark “*” further to another mark of a circle.

In the illustrated example, since the RFID tags T relating to the “ObjectName1” and the “ObjectName2” have been detected, the display of their mark portions 37 has been changed from the mark “*” to the mark of a circle. However, since the search-target selection display portion 34 has been scrolled downward, the “ObjectName1” is not displayed. Also, since the RFID tag T relating to the “ObjectName3” has not been detected, the display of the mark portion 37 remains to be “*”. Also, the display of the detection number display portion 32 is added each timer the RFID tag T to be searched is detected, and the number of search target detection of “2” is displayed here.

In the above, the mark portion 37 constitutes at least a part of display information displayed in the display device before information obtainment described in each claim.

In the above embodiment, the display information corresponding to at least one RFID tag circuit element To to be searched is displayed on the liquid crystal panel 11 of the reader 1 capable of selection. On the basis of the display, if the operator selects at least one piece of the display information, the tag ID of the RFID tag circuit element To corresponding to the selected display information is specified, and the radio communication is conducted. Via the communication, the RFID tag information is obtained from the IC circuit part 150 of the RFID tag circuit element To whose tag ID was specified. The display information on the liquid crystal panel 11 corresponding to the RFID tag circuit element To from which the information was obtained as above has at least a part of the display mode thereof changed by the display control portion 21 from that before the information obtainment.

As above, the reader 1 searches a search target whose display information is displayed on the liquid crystal panel 11 by selection and specification, and if the search is successful, at least a part of the display information is changed so as to notify it to the operator. As a result, a search operation of the search target or display of the search result can be made easier to be understood and simplified for the operator.

Also, particularly in this embodiment, the display mode of at least a part of the area of the display information displayed on the liquid crystal panel 11 before the information is obtained from the RFID tag circuit element To to be searched is changed after the information obtainment. As a result, the display mode can be changed after the information obtainment in the same screen framework as the screen actually displayed on the liquid crystal panel 11 before the information obtainment. As a result, the search success can be notified to the operator easily to be understood.

Also, particularly in this embodiment, the mark of “*” in the mark portion 37 included in the display information displayed on the liquid crystal panel 11 before the information is obtained from the RFID tag circuit element To to be searched is changed to another mark of a circle after the information obtainment. As described above, since the mark in the display information prepared in advance is changed to another mark by the display change portion 23 after the information obtainment, the successful search can be reliably notified to the operator.

Also, particularly in this embodiment, a mark is used as an identifier of the mark portion 37 for changing the display mode between before and after the information obtainment. By using the mark included in the display information as above, the successful search can be notified to the operator easily to be understood.

Also, particularly in this embodiment, the mark displayed on the liquid crystal panel 11 before obtainment of the RFID tag information is changed sequentially to another mark along an order of information obtainment. As a result, the operator can recognize the search result immediately after execution of the search, and convenience can be improved.

The present invention is not limited to the above embodiment but is capable of various variations within a range not departing from the gist and technical idea thereof. The variations will be described below in order.

(1) If the Screen is Scrolled so that the Detected RFID Tag is Displayed:

In this variation, if there are a plurality of search targets selected by the operator and all of them cannot be contained in the single screen, when the RFID tag T to be searched but not displayed is detected, the search-target selection display portion 34 is scrolled so that the display information relating to the RFID tag T can be visually recognized with priority.

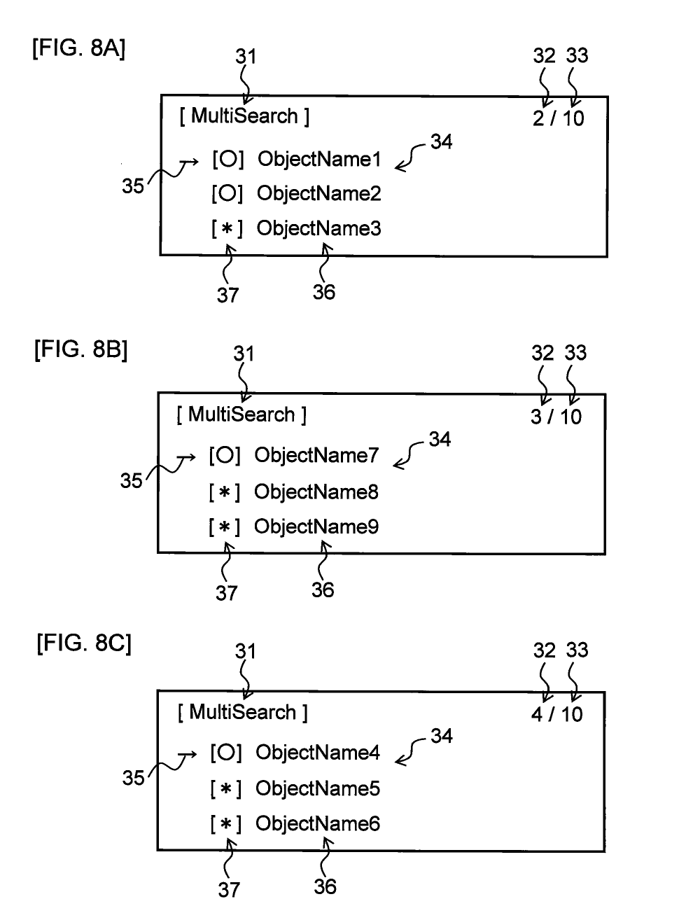

FIG. 8A shows a state in which as the result of search started by the operator by selecting 10 search targets in the multi search mode, the two RFID tags T relating to the “ObjectName1” and the “ObjectName2” are detected. Therefore, the detection number display portion 32 displays “2” and the selection number display portion 33 displays “10”.

Subsequently, if the RFID tag T relating to the “ObjectName7” is detected, the display state is as shown in FIG. 8B. That is, the search target selection display portion 34 is scrolled downward so that the detected “ObjectName7” is visually recognized with priority by control of the display change portion 23 of the display control portion 21. As a result, the “ObjectName7” is displayed to be located at the uppermost part of the search-target selection display portion 34. Also, the display of the detection number display portion 32 is added and changed to “3”.

Moreover, if the RFID tag T relating to the “ObjectName4” is detected, the display state shown in FIG. 8B is changed to the display state shown in FIG. 8C. That is, the search-target selection display portion 34 is scrolled upward so that the detected “ObjectName4” is displayed at the uppermost part of the search-target selection display portion 34. Also, the display of the detection number display portion 32 is added and changed to “4”.

The detected search target is displayed at the uppermost part of the search-target selection display portion 34 in the above, but not limited to that, it may be displayed at another position that the operator can easily recognize visually such as the lowermost part, for example.

In this variation, an arrangement order of the display information of the plurality of search targets displayed on the liquid crystal panel 11 is changed between before and after the obtainment of the RFID tag information. As a result, regardless of the arrangement order before the information obtainment, the display information of the plurality of search targets can be rearranged and displayed in the optimal arrangement order matching the situation after the information obtainment. As a result, convenience for the operator can be improved.

Also, in this variation, the arrangement order of the plurality of pieces of the display information displayed on the liquid crystal panel 11 is changed so that the information lastly obtained is visually recognized with priority. As a result, regardless of the arrangement order so far, the display information of the search target whose information is obtained lastly can be displayed in a state that the operator can visually recognize it the most. As a result, search of which search target has been completed immediately before can be notified to the operator easily to be understood, by which convenience for the operator is improved.

(2) If the Order of Detection is Displayed:

In this variation, if a search is made for a plurality of RFID tags T to be searched is conducted, numbers are displayed in the order that the information is obtained from the RFID tags T.

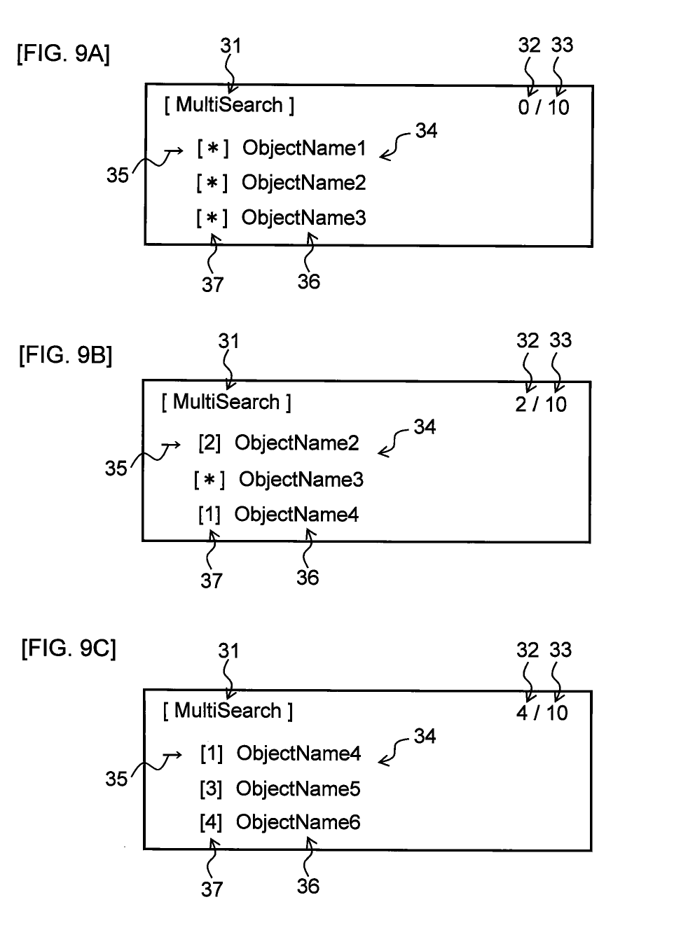

FIG. 9A shows a state in which the operator selected 10 search targets in the multi search mode. Therefore, the detection number display portion 32 displays “0”, and the selection number display portion 33 displays “10”.

Subsequently, if, as the result of search started by the operator, the RFID tag T relating to the “ObjectName4” is detected first, and the RFID tag T relating to the “ObjectName2” is detected secondly, the display state is as shown in FIG. 9B. At this time, by means of control of the display change portion 23 of the display control portion 21, a numeral, which is an identifier, is displayed at each of the mark portions 37 corresponding to the search targets. The numerals indicate the order by which information of the RFID tags T of the corresponding search targets is obtained. That is, “1” is displayed in the mark portion 37 corresponding to the “ObjectName4”, and “2” is displayed in the mark portion 37 corresponding to the “ObjectName2”. Also, the display of the detection number display portion 32 is added and changed to “2”.

Moreover, if the RFID tag T relating to the “ObjectName5” is detected thirdly, and the RFID tag T relating to the “ObjectName6” is detected fourthly, the display state is as shown in FIG. 9C. That is, “3” is displayed in the mark portion 37 corresponding to the “ObjectName5”, and “4” is displayed in the mark portion 37 corresponding to the “ObjectName6”. Also, the display of the detection number display portion 32 is added and changed to “4”.

In the above variation, at least a part of the marks displayed on the liquid crystal panel 11 before the information obtainment is changed to a numeral indicating the order information of the information obtainment after the information obtainment. As a result, the operator can estimate that the RFID tag T from which the information could be obtained in the relatively early order is located relatively close to himself or herself. Also, if the operator makes a search while moving, for example, the presence position or direction of the RFID tag T can be estimated referring to the moving direction.

(3) If Received Signal Intensity is Displayed:

In this variation, if a search is made for a plurality of search targets, received signal intensity from the RFID tag circuit element To of each of the RFID tags T to be searched is detected. Then, after the RFID tag information is obtained from the RFID tag circuit element To, information corresponding to the received signal intensity is displayed.

As described above, outputs of the I-phase receiving signal amplifier 221 and the Q-phase receiving signal amplifier 225 are inputted to the RSSI circuit 226, and the signals “RSSI” indicating the intensity of the signals are inputted to the CPU 4. The display change portion 23 of the display control portion 21 receives inputs of the intensity signals RSSI from the CPU 4. On the basis of the intensity signals RSSI, the display change portion 23 changes a part of the mark portion 37 displayed on the liquid crystal panel 11 before the information obtainment to another mark indicating received signal intensity information after the information obtainment.

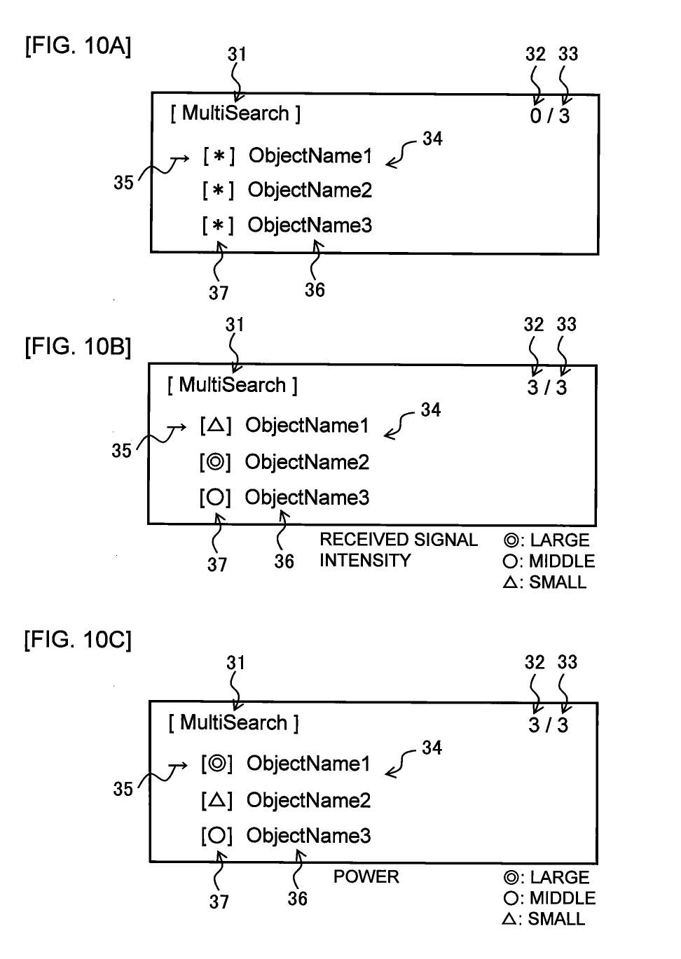

FIG. 10A shows a state before a search is made, in which the operator selected three search targets in the multi search mode. Therefore “0” is displayed in the detection number display portion 32, and “3” is displayed in the selection number display portion 33.

Subsequently, if all the RFID tags T relating to the selected three “ObjectName1” to “ObjectName3” are detected as the result of start of a search by the operator, the display state is as shown in FIG. 10B. At this time, by means of control of the display change portion 23 of the display control portion 21, a mark, which is an identifier indicating received signal intensity, is displayed, respectively, in the mark portion 37 corresponding to each of the search targets.

In this example, a mark of a triangle indicating that the received signal intensity is small is displayed in the mark portion 37 corresponding to the “ObjectName1”. Also, a mark of double circles indicating that the received signal intensity is large is displayed in the mark portion 37 corresponding to the “ObjectName2”. Also, a mark of a circle indicating that the received signal intensity is medium is displayed in the mark portion 37 corresponding to the “ObjectName3”. Also, the display of the detection number display portion 32 is changed to “3”.

According to this variation, the operator can estimate a distance to each of the RFID tag T on the basis of the received signal intensity information such that the larger the received signal intensity is, the smaller the distance to the RFID tag T as a search target from the reader 1 is.

The case in which the distance to the RFID tag T as a search target is estimated using the signal “RSSI” indicating the signal intensity outputted from the RSSI circuit 226 is shown in the above, but not limited to that. That is, as described above, the operator can adjust the power of the reader 1 in a stepped manner using the knob 18a. When the power to the plurality of specified RFID tags T as search targets is changed by the operation of the knob 18a in a stepped manner, availability of radio communication with each RFID tag T is determined by the reader 1 in each stage. For example, it is determined that the distance to the RFID tag T detected if the power set by the knob 18a is relatively large is relatively far, while the distance to the RFID tag T detected if the power set by the knob 18a is relatively small is relatively near, and the distance to the RFID tag T detected if the power set by the knob 18a is medium is medium. In this way, on the basis of the power value in detection, the reader 1 can detect an approximate separation distance from the reader 1 to the RFID tag T as a search target. In this case, as shown in FIG. 10C, the power information in detection may be displayed for each search target. Alternatively, the separation distance to the RFID tag T detected on the basis of the power may be displayed.

(4) Variations of Display Change

In the above, the case in which the mark or numeral of the mark portion 37 is changed between before and after the selection of the search target and before and after the obtainment of the RFID tag information has been described as an example. In this variation, instead of the above, at least any of a display color, a font, and decoration, for example, is changed in addition to the above. The change of the font includes change of a size of a character or a line, change of thickness of a character or a line, and an italic type, for example. The change of decoration includes shading, inversion, and addition of an underline, for example.

In this example, the case in which, as the result of search by the operator who selected the three RFID tags T relating to the “ObjectName1” to “ObjectName3” in the multi search mode, the two RFID tags T relating to the “ObjectName1” and “ObjectName3” are detected will be described as an example.

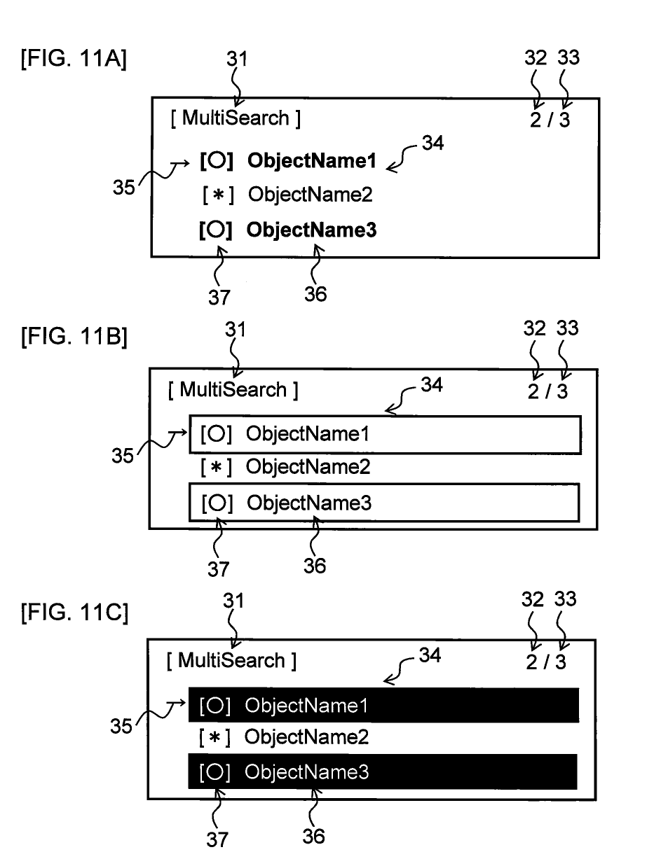

FIG. 11A shows an example in which the thickness of the mark portion 37 and letters in the text portion 36 is changed in addition to the mark change from the “*” to a circle in the mark portion 37 with regard to the detected RFID tag T. FIG. 11B shows an example in which shading is given to the mark portion 37 and letters in the text portion 36 in addition to the mark change from the “*” to a circle in the mark portion 37 with regard to the detected RFID tag T. However, in FIG. 11B, shading is omitted in order to prevent complicatedness and only outer frames of the shaded areas are shown. FIG. 11C shows an example in which inversion is applied to the mark portion 37 and the text portion 36 in addition to the mark change from the “*” to a circle in the mark portion 37 with regard to the detected RFID tag T to be searched.

According to this variation, a search of which search target has been completed can be notified to the operator more easily to be understood, by which convenience for the operator is improved.

(5) If an Information Amount to be Displayed is Increased:

In this variation, the information amount included in the display information displayed on the liquid crystal panel 11 before the information obtainment from the RFID tag T to be searched is increased after the information obtainment.

FIG. 12A shows a state before the search in which the operator selected 10 search targets in the multi search mode. Therefore, “0” is displayed in the detection number display portion 32, and “10” is displayed in the selection number display portion 33.

Subsequently, as the result of search started by the operator, if the RFID tags T relating to the “ObjectName2” and the “ObjectName3” are detected, the display state is as shown in FIG. 12B. At this time, the display information amount at the uppermost part of the search-target selection display portion 34 is increased by control of the information amount increase portion 24 in the display control portion 21, and names of the “ObjectName2” and the “OBjectName3” are displayed in the applicable portions. At this time, the mark change is made from “*” to a circle in the mark portion 37 at the uppermost part, and the display of the detection number display portion 32 is changed to “2”.

After that, if the RFID tags T relating to the “ObjectName5” and the “ObjectName6” are further detected, the display state is as shown in FIG. 12C. At this time, the display at the uppermost part of the search-target selection display portion 34 is scrolled laterally by control of the information amount increase portion 24 in the display control portion 21, and all the names of the “ObjectName2”, “OBjectName3”, “ObjectName5”, and “ObjectName6” are displayed. The display of the detection number display portion 32 is added and changed to “4”.

In the above, the display information amount at the uppermost part of the search-target selection display portion 34 is increased, but not limited to that, the display information amounts at other positions may be increased.

According to this variation, the information amount displayed at the uppermost part of the search-target selection display portion 34 in the liquid crystal panel 11 before obtainment of the RFID tag information of the RFID tag T as a search target is increased after the information obtainment, and all the display is made for the RFID tags T for which a search has been completed only at the uppermost part while being scrolled laterally. As a result, the other display such as display of the names relating to the undetected RFID tags T, for example, can be made in a part other than the uppermost part of the search-target selection display portion 34. Therefore, the display information amount of the entire liquid crystal panel 11 can be increased. Also, even if the name relating to the detected RFID tag T is long, the entirety can be displayed by lateral scroll. Also, with regard to the detected RFID tags T, detailed information other than the name such as a tag ID and a separation distance can be displayed so as to notify it to the operator.

(6) If a Display Area Other Than the Information Relating to the Detected RFID Tag is Deleted:

In this variation, with the sequential increase of the number of the RFID tags T for which obtainment of the RFID tag information has been completed, a display area other than the display information relating to the detected RFID tag T in the liquid crystal panel 11 is deleted. As a result, the display information relating to the plurality of RFID tags T for which information obtainment has been completed can be displayed in a list.

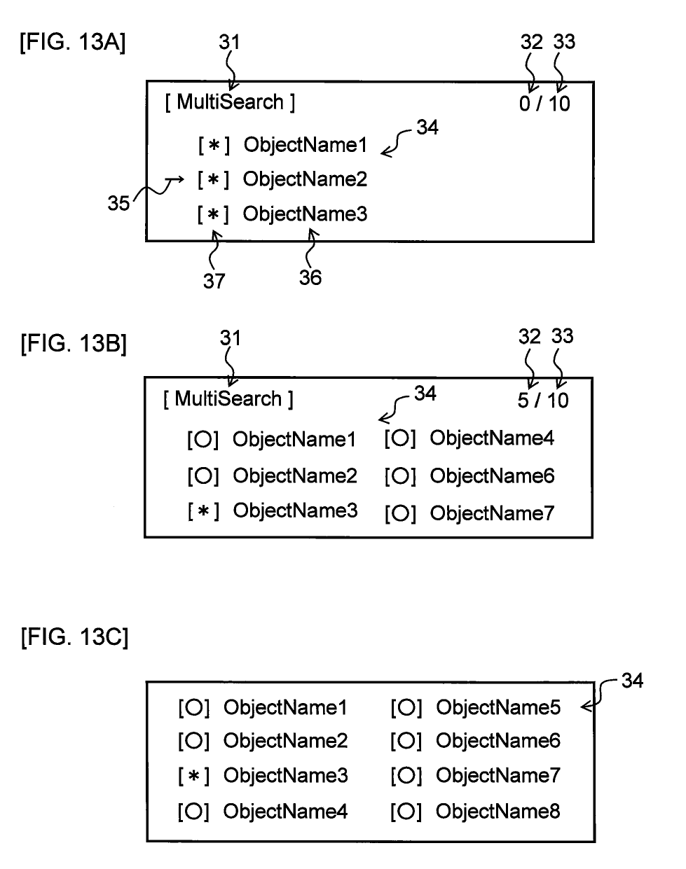

FIG. 13A shows a state before search in which the operator selected ten search targets in the multi search mode. Therefore, “0” is displayed in the detection number display portion 32 and “10” is displayed in the selection number display portion 33.

Subsequently, as the result of search started by the operator, if five RFID tags T relating to the “ObjectName1”, “ObjectName2”, “ObjectName4”, “ObjectName6”, and “OBjectName7” are detected, the display state is as shown in FIG. 13B. That is, by means of control of the display area deletion portion 25 of the display control portion 21, the display area of the cursor portion 35 is deleted. Also, the display area of the search-target selection display portion 34 is expanded, and all the names of the “ObjectName1”, “ObjectName2”, “ObjectName4”, “ObjectName6”, and “OBjectName7” relating to the detected five RFID tags T are displayed in the area. At this time, the marks in the corresponding mark portions 37 are changed from “*” to a circle, and the display of the detection number display portion 32 is added and changed to “5”.

After that, if the RFID tags T relating to the “ObjectName5” and “ObjectName8” are further detected, the display state is as shown in FIG. 13C. That is, by means of control of the display area deletion portion 25 in the display control portion 21, the display areas of the mode display portion 31, the detection number display portion 32, and the selection number display portion 33 are deleted. Then, the display area of the search-target selection display portion 34 is expanded to the entire display screen of the liquid crystal panel 11, and all the names relating to the detected RFID tags T are displayed in the expanded area.

According to this variation, with the sequential increase of the number of the RFID tags T for which obtainment of the RFID tag information has been completed, a display area other than the display information of the detected RFID tag T in the liquid crystal panel 11 is deleted. Then, the display information relating to the plurality of RFID tags T for which information obtainment has been completed can be displayed in a list. As a result, the names relating to all the RFID tags T for which the search has been completed can be displayed without missing even if the other display areas are sacrificed and the names can be reliably notified to the operator. Also, since the display screen by the liquid crystal panel 11 can be used for display of only the information relating to the detected RFID tags T, the limited display screen can be effectively used.

(7) If the Information Relating to the Detected RFID Tag is Not to be Displayed:

In this variation, each time the obtainment of the RFID tag information from the plurality of RFID tags T to be searched is completed, the RFID tag T for which information has been obtained is not displayed on the liquid crystal panel 11.

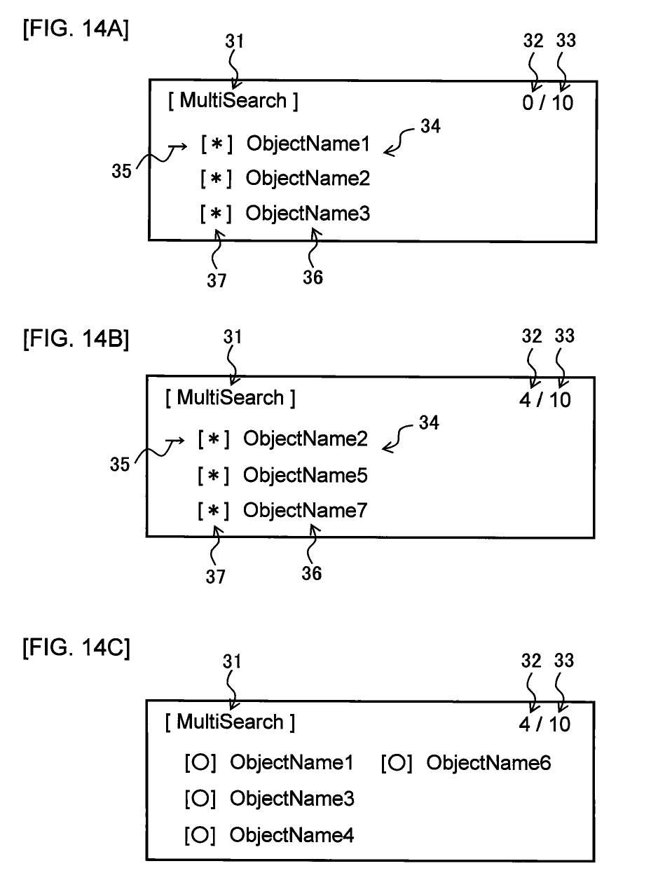

FIG. 14A shows a state before the search in which the operator selected ten search targets in the multi search mode. Therefore, “0” is displayed in the detection number display portion 32 and “10” is displayed in the selection number display portion 33.

Subsequently, as the result of search started by the operator, if four RFID tags T relating to the “ObjectName1”, “ObjectName3”, “ObjectName4”, and “ObjectName6” are detected, the display state is as shown in FIG. 14B. That is, by means of control of the display control portion 21, the names of the “ObjectName1”, “ObjectName3”, “ObjectName4”, and “ObjectName6” relating to the detected four RFID tags T are deleted from the screen and switched to non-display. At this time, the display of the detection number display portion 32 is changed to “4”.

According to this variation, since the search targets for which the search has been completed sequentially become non-display, the operator can easily recognize the search targets for which the search has not been finished.

In the above variation, the display information having been switched to the non-display may be displayed in another screen of the liquid crystal panel 11 by an appropriate operation by the operator as shown in FIG. 14C. As a result, the operator can display and confirm the search target which has been made non-display once and for which the search has been completed in another screen as necessary.

(8) If a Result is Displayed at Timeout:

In this variation, a search result is displayed on the liquid crystal panel 11 at search start by the reader 1, that is, after a predetermined time has elapsed since the operation of the transmission key 16.

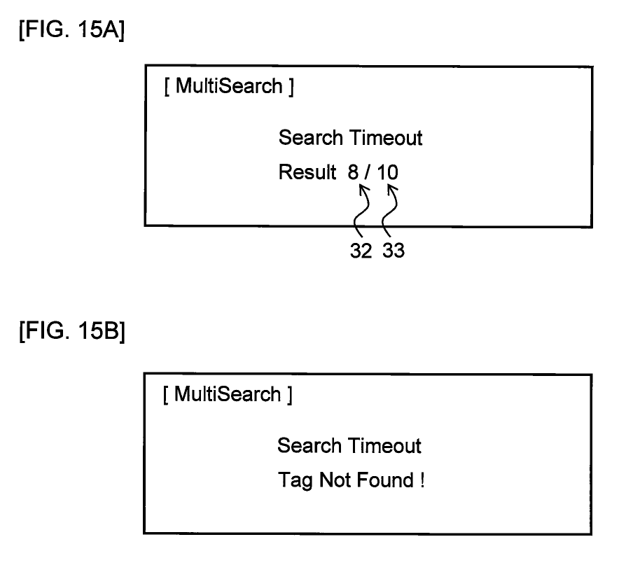

FIG. 15A is an example of display of a case in which, as the result of selection and search of ten search targets by the operator in the multi search mode, eight RFID tags T as search targets in them are detected till a predetermined time has elapsed.

In this example, by means of control of the display control portion 21, display of “Search Timeout” that the predetermined time has elapsed since the search start is displayed in the liquid crystal panel 11. Also, the detection number of the RFID tags T as search targets is displayed in the detection number display portion 32 as a search result, and the number of search targets selected by the operator is displayed in the selection number display portion 33.

Also, FIG. 15B shows an example of display of a case in which no RFID tag T as a search target can be detected till the predetermined time has elapsed. In this variation, if the predetermined time has elapsed since the search start, a search operation by the reader 1, that is, signal transmission to the RFID tag T as a search target is automatically stopped.

According to this variation, regardless of success or failure of the search for the RFID tag T to be searched or size of the number of search targets for which the search was successful, the search result can be reliably notified to the operator after a predetermined time has elapsed. Also, since the search operation is stopped after the predetermined time has elapsed, battery consumption of the reader 1 can be saved.

(9) If Sound Alarm is Made:

In this variation, when the display mode is to be changed as above, sound alarm is made by the sound alarm portion 22. For example, if the RFID tag T to be searched is detected via radio communication, the sound alarm portion 22 makes sound alarm such that “ObjectName1 has been detected”, for example.

According to this variation, the fact that the search for the RFID tag T to be searched has been completed can be also aurally notified to the operator, by which convenience for the operator is improved. Also, as a result, the fact that the search for the search target has been completed can be known without visual confirmation on the liquid crystal panel 11.

Other than those described above, methods of the embodiment and each variation may be combined as appropriate for use.

Though not specifically exemplified, the present invention should be put into practice with various changes made in a range not departing from its gist.

What is claimed is:

1. A handheld apparatus for reading radio frequency identification (RFID) tag information comprising:
a radio communicating device configured to conduct radio communication with a plurality of RFID tag circuit elements including an IC circuit part storing information and a tag antenna capable of information transmission and reception;
a display device configured to display display information corresponding to at least one of said RFID tag circuit elements as search targets so that an operator can select;
an information obtainment device configured to specify identification information of at least one of said RFID tag circuit elements selected by said operator among said RFID tag circuit elements as the search targets whose display information is displayed on said display device, to conduct communication through said radio communicating device, and to obtain information from said IC circuit part of the RFID tag circuit element specified; and
a display control portion configured, when said information obtainment device obtains the information from said RFID tag circuit element, to make a display mode of said display information corresponding to the RFID tag circuit element on said display device different at least partially from a display mode of the display information corresponding to the RFID tag circuit element before the obtainment of information.

2. The handheld apparatus according to claim 1, wherein:
said display control portion includes a display change portion configured to change a display mode of an area of at least a part of display information after the obtainment of information, the display information displayed on the display device before the obtainment of information obtainment.

3. The handheld apparatus according to claim 2, wherein:
said display change portion changes an arrangement order of said plurality of pieces of display information respectively corresponding to the plurality of said RFID tag circuit elements displayed on said display device between before and after the obtainment of information by said information obtainment device.

4. The handheld apparatus according to claim 3, wherein:
said display change portion changes the arrangement order of said plurality of pieces of display information displayed on said display device so that the information obtained lastly can be visually recognized with priority.

5. The handheld apparatus according to claim 2, wherein:
said display change portion changes an identifier included in at least one piece of display information displayed on the display device before the obtainment of information to another identifier after the obtainment of information.

6. The handheld apparatus according to claim 5, wherein:
the handheld apparatus uses a numeral or a mark as said identifier.

7. The handheld apparatus according to claim 5, wherein:
said display change portion changes said identifier displayed on the display device before the obtainment of information to said another identifier sequentially on the basis of an order of the obtainment of information.

8. The handheld apparatus according to claim 7, wherein:
said display change portion changes at least one of the identifiers displayed on the display device before the obtainment of information to the another identifier indicating order information of the obtainment of information after the obtainment of information.

9. The handheld apparatus according to claim 7, wherein:
said radio communicating device has an intensity detecting device configured to detect received signal intensity from said RFID tag circuit element; and
said display change portion changes, after the obtainment of information, at least one of the identifiers displayed on the display device before the obtainment of information to the another identifier indicating received signal intensity information detected by said intensity detecting device at the obtainment of information.

10. The handheld apparatus according to claim 2, wherein:
said display change portion changes at least any of a color, a font and decoration relating at least one of the plurality of identifiers displayed on the display device between before and after the obtainment of information.

11. The handheld apparatus according to claim 1, wherein:
said display control portion includes an information amount increasing portion configured to increase, after the obtainment of information, an information amount included in said display information displayed on the display device before the obtainment of information.

12. The handheld apparatus according to claim 1, wherein:
said display control portion includes a display area deletion portion configured, according to a sequential increase of the number of said RFID tag circuit elements for which an information obtainment has been completed by said information obtainment device, to delete a display area other than a plurality of pieces of the display information in said display device so that the plurality of pieces of the display information can be displayed in a list, the plurality of pieces of the display information relating to plurality of the RFID tag circuit elements for which information obtainment has been completed.

13. The handheld apparatus according to claim 1, wherein:
said display control portion switches said display information into a non-display state after the obtainment of information, the display information displayed on the display device before the obtainment of information by said information obtainment device.

14. The handheld apparatus according to claim 13, wherein:
said display control portion control said display device so as to display said display information having been switched into said non-display state, in another screen of said display device.

15. The handheld apparatus according to claim 2, further comprising
a sound alarm portion configured, when said information obtainment device obtains information from said RFID tag circuit element, to make a sound alarm corresponding to the obtainment of information.

16. The handheld apparatus according to claim 2, wherein:
said display control portion displays a result display screen according to an information obtainment result by said information obtainment device on said display device after a predetermined time has elapsed since start of the obtainment of information by said information obtainment device.
